(19) United States
(12) Patent Application Publication
(10) Pub. No.: US 2005/0131674 A1
(43) Pub. Date: Jun. 16, 2005

(54) Information processing apparatus and its control method, and program

(75) Inventor: Michio Aizawa, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 11/000,060

(22) Filed: Dec. 1, 2004

(30) Foreign Application Priority Data
Dec. 12, 2003 (JP) 2003-415426

(51) Int. Cl. G06F 17/27

(52) U.S. Cl. 704/9; 704/1

(57) ABSTRACT

A notation character string division unit acquires a word to be processed from a word dictionary which includes a plurality of words each having notation information and pronunciation information, and divides its notation into a plurality of partial character strings. A partial character string coupling unit generates new partial character strings by coupling neighboring ones of the plurality of divided partial characters. A pronunciation rule generation unit determines pronunciations corresponding to the obtained partial character strings, and registers sets of partial character strings and pronunciations as pronunciation rules in a pronunciation rule holding unit. A pronunciation rule deletion unit deletes registered pronunciation rules on the basis of the frequencies of occurrence of pronunciation rules registered in the pronunciation rule holding unit.

### FIELD OF THE INVENTION

The present invention relates to an information processing apparatus for generating pronunciation rules used to estimate the pronunciation of a word or for estimating the pronunciation of a word to be processed, its control method, and a program.

### BACKGROUND OF THE INVENTION

As a method of estimating the pronunciation of a given word from the notation of that word, a method of decomposing the notation into partial character strings, and coupling pronunciations corresponding to the partial character strings to obtain the pronunciation of that word is popularly used. In this method, pronunciations corresponding to partial character strings are prepared as pronunciation rules.

FIG. 9 shows an example of pronunciation rules.

For example, a pronunciation rule in the first line indicates that a pronunciation corresponding to a partial character string “a” is “ei”, and a pronunciation rule in the second line indicates that a pronunciation corresponding to a partial character string “at” is “{t”. Note that a pronunciation is expressed using alphabets and symbols.

A case will be exemplified below wherein the pronunciation of a word “moderation” is to be estimated.

The word notation “moderation” is divided into partial character strings included in the pronunciation rules (FIG. 9). In this case, this notation can be divided into four partial character strings “mod/er/a/tion”.

Pronunciations corresponding to these partial character strings are extracted from the pronunciation rules, and are coupled to estimate the pronunciation of the whole word. In this case since a pronunciation corresponding to the partial character string “mod” is “mad”, that corresponding to the partial character string “er” is “@r”, that corresponding to the partial character string “a” is “ei”, and that corresponding to the partial character string “tion” is “S@n”, these pronunciations are coupled to estimate the pronunciation of the word “moderation” as “mad@reiS@n”.

Conventionally, in association with a method of generating pronunciation rules as a pronunciation estimation apparatus using these partial character string, U.S. Pat. No. 6,347,295 “COMPUTER METHOD AND APPARATUS FOR GRAPHEME-TO-PHONEME RULE-SET-GENERATION” is known. Also, as a method of estimating a pronunciation using the pronunciation rules generated using the aforementioned method, U.S. Pat. No. 6,076,060 “COMPUTER METHOD AND APPARATUS FOR TRANSLATING TEXT TO SOUND” is known.

In these methods of U.S. Pat. Nos. 6,347,295 and 6,076,060, pronunciation rules associated with prefixes, suffixes, and interiors of words are separately generated and used.

However, when the pronunciation of a word is estimated by the method of U.S. Pat. No. 6,076,060, pronunciation rules associated with prefixes, suffixes, and interiors of words must be selectively used in accordance with the positions of partial character strings in a word, resulting in complicated processes.

On the other hand, the pronunciation estimation apparatus which uses partial character strings, as disclosed in U.S. Pat. No. 6,347,295, generally suffers the following problems.

For example, when a word “moderation” is divided into “mod/er/a/tion”, the pronunciation of a partial character string “a” is “ei”. However, when another word “analog” is divided into “an/a/log”, the pronunciation of a partial character string “a” is “V”. That is, different pronunciations may occur for an identical partial character string.

Even when pronunciation rules are generated by dividing the word “moderation” into “mod/er/a/tion”, that word is likely to be divided into different partial character strings “mode/ra/tion”. For this reason, when a given word is divided into different partial character strings upon generation and estimation, a pronunciation is likely to be incorrectly estimated.

### SUMMARY OF THE INVENTION

The present invention has been made to solve the aforementioned problems, and has as its object to provide an information processing apparatus which can generate pronunciation rules that allow to estimate the pronunciation of a word to be processed more appropriately, and can estimate a more appropriate pronunciation by estimating the pronunciation using the pronunciation rules, its control method, and a program.

According to the present invention, the foregoing object is attained by providing an information processing apparatus, comprising: division means for acquiring a word to be processed from a word dictionary which includes a plurality of word each having notation information and pronunciation information, and dividing a notation of the acquired word into a plurality of character strings; coupling means for generating partial character strings by coupling neighboring ones of the plurality of partial character strings divided by the division means; registration means for determining pronunciations corresponding to the partial character strings obtained by the division means and the coupling means, and registering sets of partial character strings and pronunciations as pronunciation rules in a pronunciation rule holding unit; and deletion means for deleting registered pronunciation rules on the basis of frequencies of occurrence of pronunciation rules registered in the pronunciation rule holding unit.

In a preferred embodiment, when pronunciation rules having different pronunciations are registered in correspondence with a single partial character string in the pronunciation rule holding unit, the deletion means deletes pronunciation rules other than a pronunciation rule with a highest frequency of occurrence.

In a preferred embodiment, the apparatus further comprises: receive means for receiving a word whose pronunciation is to be estimated; selection means for selecting pronunciation rules from the pronunciation rule holding unit using information of a plurality of partial character strings obtained by dividing a notation of the word whose pronunciation is to be estimated by the division means; and estimation means for estimating a pronunciation of the word whose pronunciation is to be estimated using the pronunciation rules selected by the selection means.

In a preferred embodiment, the division means divides the notation of the word into a plurality of partial character strings using vowel letter-consonant letter information.

In a preferred embodiment, the division means divides the notation of the word into a plurality of partial character strings using information associated with syllabic divisions.

According to the present invention, the foregoing object is attained by providing an information processing apparatus, comprising: receive means for receiving a notation of the word to be processed; division means for dividing the notation of the word to be processed into a plurality of partial character strings; selection means for selecting pronunciation rules from holding means that holds pronunciation rules using information of the partial character strings divided by the division means; and estimation means for estimating a pronunciation of the word to be processed using the pronunciation rules selected by the selection means.

In a preferred embodiment, the division means divides the notation of the word into a plurality of partial character strings using vowel letter-consonant letter information.

In a preferred embodiment, the division means divides the notation of the word into a plurality of partial character strings using information associated with syllabic divisions.

In a preferred embodiment, the selection means selects a pronunciation rule that matches a division position of each partial character string divided by the division means and corresponds to a longest partial character string.

According to the present invention, the foregoing object is attained by providing a method of controlling an information processing apparatus, comprising: a division step of acquiring a word to be processed from a word dictionary which includes a plurality of word each having notation information and pronunciation information, and dividing a notation of the acquired word into a plurality of character strings; a coupling step of generating partial character strings by coupling neighboring ones of the plurality of partial character strings divided in the division step; a registration step of determining pronunciations corresponding to the partial character strings obtained in the division step and the coupling step, and registering sets of partial character strings and pronunciations as pronunciation rules in a pronunciation rule holding unit; and a deletion step of deleting registered pronunciation rules on the basis of frequencies of occurrence of pronunciation rules registered in the pronunciation rule holding unit.

According to the present invention, the foregoing object is attained by providing a method of controlling an information processing apparatus, comprising: an receive step of receiving a notation of the word to be processed; a division step of dividing the notation of the word to be processed into a plurality of partial character strings; a selection step of selecting pronunciation rules from a pronunciation rule holding unit that holds pronunciation rules using information of the partial character strings divided in the division step; and an estimation step of estimating a pronunciation of the word to be processed using the pronunciation rules selected in the selection step.

According to the present invention, the foregoing object is attained by providing a program for implementing control of an information processing apparatus, comprising: a program code of a division step of acquiring a word to be processed from a word dictionary which includes a plurality of word each having notation information and pronunciation information, and dividing a notation of the acquired word into a plurality of character strings; a program code of a coupling step of generating partial character strings by coupling neighboring ones of the plurality of partial character strings divided in the division step; a program code of a registration step of determining pronunciations corresponding to the partial character strings obtained in the division step and the coupling step, and registering sets of partial character strings and pronunciations as pronunciation rules in a pronunciation rule holding unit; and a program code of a deletion step of deleting registered pronunciation rules on the basis of frequencies of occurrence of pronunciation rules registered in the pronunciation rule holding unit.

According to the present invention, the foregoing object is attained by providing a program for implementing control of an information processing apparatus, comprising: a program code of an receive step of receiving a notation of the word to be processed; a program code of a division step of dividing the notation of the word to be processed into a plurality of partial character strings; a program code of a selection step of selecting pronunciation rules from a pronunciation rule holding unit that holds pronunciation rules using information of the partial character strings divided in the division step; and a program code of an estimation step of estimating a pronunciation of the word to be processed using the pronunciation rules selected in the selection step.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing the functional arrangement of a pronunciation estimation apparatus according to the first embodiment of the present invention;

FIG. 2 is a flowchart showing the process to be executed by the pronunciation estimation apparatus according to the first embodiment of the present invention;

FIG. 3 is a view for explaining correspondence between a notation and a pronunciation character string according to the first embodiment of the present invention;

FIG. 4 shows an example of pronunciation rules according to the first embodiment of the present invention;

FIG. 5 is a block diagram showing the functional arrangement of a pronunciation estimation apparatus according to the second embodiment of the present invention;

FIG. 6 is a flowchart showing the process to be executed by the pronunciation estimation apparatus according to the second embodiment of the present invention;

FIG. 7 shows an example of pronunciation rules according to the second embodiment of the present invention;

FIG. 8A is a view for explaining a sequence for selecting pronunciation rules according to the second embodiment of the present invention;

FIG. 8B is a view for explaining a sequence for selecting pronunciation rules according to the second embodiment of the present invention;

FIG. 8C is a view for explaining a sequence for selecting pronunciation rules according to the second embodiment of the present invention; and

FIG. 9 shows an example of pronunciation rules.

### DETAILED DESCRIPTION OF THE PREFERRED EMBODIMENTS

Preferred embodiments of the present invention will now be described in detail in accordance with the accompanying drawings.

### First Embodiment

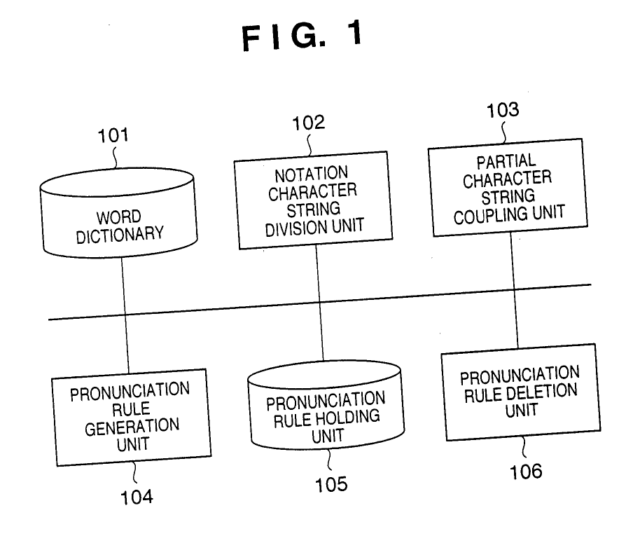

FIG. 1 is a block diagram showing the functional arrangement of a pronunciation estimation apparatus according to the first embodiment of the present invention.

Reference numeral 101 denotes a word dictionary which stores and manages a plurality of words each having word notation and pronunciation information required to generate pronunciation rules. Reference numeral 102 denotes a notation character string division unit which divides a character string of a notation of a word to be processed into partial character strings.

Reference numeral 103 denotes a partial character string coupling unit which generates new partial character strings by coupling a plurality of neighboring partial character strings of a plurality of partial character strings generated by the notation character string division unit 102. Reference numeral 104 denotes a pronunciation rule generation unit which determines pronunciations corresponding to respective partial character strings, and registers sets of partial character strings and pronunciations in a pronunciation rule holding unit 105 as pronunciation rules.

Reference numeral 105 denotes a pronunciation rule holding unit which holds pronunciation rules. Reference numeral 106 denotes a pronunciation rule deletion unit which deletes unnecessary ones from pronunciation rules.

Note that this pronunciation estimation apparatus may be implemented either by dedicated hardware or as a program that runs on a general-purpose computer (information processing apparatus) such as a personal computer or the like. This general-purpose computer has, e.g., a CPU, RAM, ROM, hard disk, external storage device, network interface, display, keyboard, mouse, microphone, loudspeaker, and the like as standard building components.

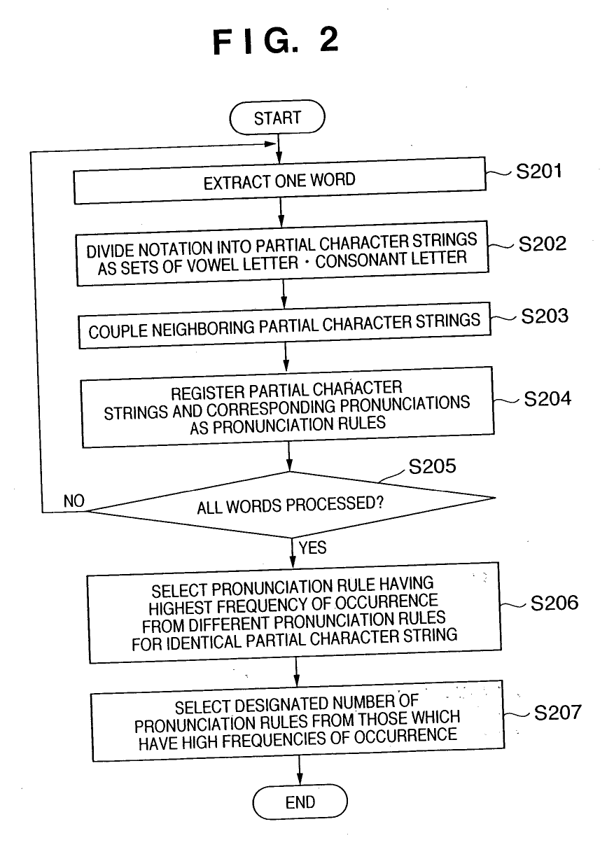

The process to be executed by the pronunciation estimation apparatus of the first embodiment will be explained below using FIG. 2.

FIG. 2 is a flowchart showing the process to be executed by the pronunciation estimation apparatus according to the first embodiment of the present invention.

Note that FIG. 2 will explain the process for generating pronunciation rules required to estimate a pronunciation of a word.

In step S201, one of unprocessed words is extracted from the word dictionary 101. A case will be exemplified below wherein a word with a notation “dedicate” and pronunciation “dedikeit” is extracted from the word dictionary 101.

In step S202, the notation character string division unit 102 divides the notation “dedicate” of the word into partial character strings as sets of vowel letter-consonant letter. Note that “aeiou” are vowel letters, and other alphabets are consonant letters. Division is made using the following rules in, e.g., “ROYAL DICTIONNAIRE FRANCAIS-JAPONAIS” (Obunsha Co., Ltd.):
Consonant letters at the beginning and ending of a word couple to the next or immediately preceding vowel letter.
One consonant letter sandwiched between vowel letters belongs to the next partial character string.
Two consonant letters sandwiched between vowel letters are divided at a position between them.
When three or more consonant letters successively appear, they are divided at a position before the last consonant letter.

When the aforementioned rules are used, “dedicate” is divided into four partial character strings “de/di/ca/te”.

In step S203, the partial character string coupling unit 103 generates new partial character strings by coupling a plurality of neighboring partial character strings.

For example, a partial character string “dedi” is generated by coupling the partial character string “de” and right neighboring “di”. For example, if the number of partial character strings to be coupled is 2, three new partial character strings “dedi”, “dica”, and “cate” are generated. Note that the number of partial character strings to be coupled is not limited to 2, but three or more partial character strings may be coupled.

In step S204, the pronunciation rule generation unit 104 generates pronunciations corresponding to the partial character strings as pronunciation rules, and registers them in the pronunciation rule holding unit 105.

Note that the pronunciations corresponding to the partial character strings can be determined by, e.g., the following method.

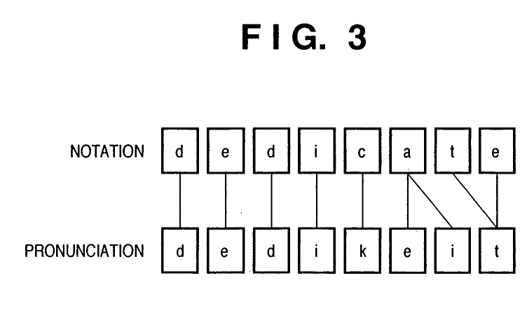

For example, the word notation “dedicate” and pronunciation “dedikeit” are associated with each other using DP matching. FIG. 3 shows an example of this association result. In this association result, pronunciations corresponding to partial character strings can be determined: a pronunciation corresponding to the partial character string “de” is “de”, that corresponding to the partial character string “di” is “di, and so forth.

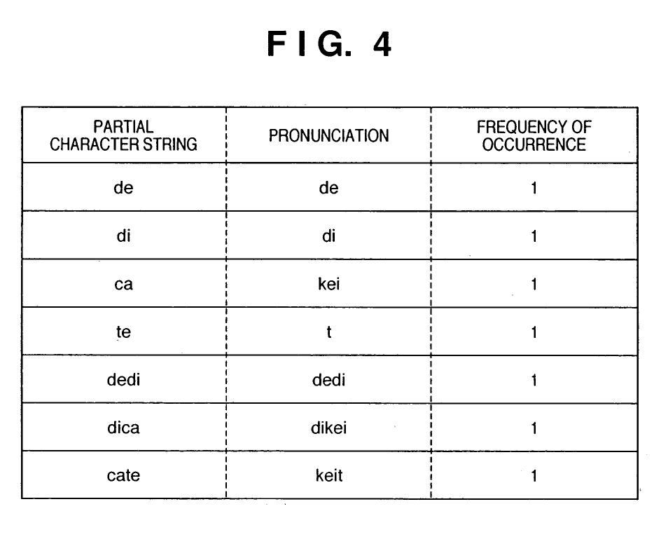

FIG. 4 shows the pronunciation rules to be registered in the pronunciation rule holding unit 105, which are obtained based on these partial character strings.

In the example of FIG. 4, since the four partial character strings are generated in step S202 and the three partial character strings are generated in step S203, a total of seven pronunciation rules are registered in the pronunciation rule holding unit 105 on the basis of “dedicate”. Upon registering the pronunciation rules, if an identical pronunciation rule has already been registered, its frequency of occurrence (registration frequency of occurrence) is incremented by “1”; if a given pronunciation rule has not been registered yet, its frequency of occurrence is set to be “1”.

It is checked in step S205 if the processes of all words are complete. If words to be processed still remain (NO in step S205), the flow returns to step S201 to extract an unprocessed word from the word dictionary 101. If the processes of all words are complete (YES in step S205), the flow advances to step S206.

If pronunciation rules having different pronunciations for an identical partial character string are registered in the pronunciation rule holding unit 105, the pronunciation rule deletion unit 106 selects the pronunciation rule with the highest frequency of occurrence, and deletes other pronunciation rules in step S206.

For example, assume that a pronunciation rule with a pronunciation “V” and that with a pronunciation “ei” are registered in the pronunciation rule holding unit 105 in correspondence with a partial character string “a”, the frequency of occurrence of the pronunciation rule with a pronunciation “V” is 1400, and that of the pronunciation rule with a pronunciation “ei” is 200. In this case, the pronunciation rule deletion unit 106 selects the pronunciation rule with a pronunciation “V” for the partial character string “a”, and deletes the pronunciation rule with a pronunciation “ei” for the partial character string “a” from the pronunciation rule holding unit 105.

In step S207, the pronunciation rule deletion unit 106 selects the designated number of pronunciation rules from those selected in step S206 in descending order of frequency of occurrence, and deletes other the pronunciation rules.

As described above, according to the first embodiment, when different pronunciation rules are registered in the pronunciation rule holding unit in correspondence with an identical partial character string, pronunciation rules which seem unnecessary are deleted on the basis of the frequencies of occurrence of respective pronunciation rules.

In this way, pronunciation rules which seem appropriate as the pronunciations of words can be stored and managed. Since pronunciation rules which seem unnecessary are deleted, the storage resource required to store and manage pronunciation rules can be effectively used.

Also, since the partial character string coupling unit 103 generates new partial character strings, and generates pronunciation rules for these partial character strings, a problem of different pronunciations occurring for an identical character string can be avoided. For example, “mod/er/a/tion” and “an/a/log” have different pronunciations for a partial character string “a”. However, by generating a partial character string “ation”, the divided partial character strings of “moderation” are changed to “mod/er/ation”, and the pronunciation of the partial character string “a” can be narrowed down to one.

### Second Embodiment

In the first embodiment, the process for generating pronunciation rules required to estimate the pronunciation of a word has been explained. In the second embodiment, a process for estimating the pronunciation of a word using the generated pronunciation rules will be explained.

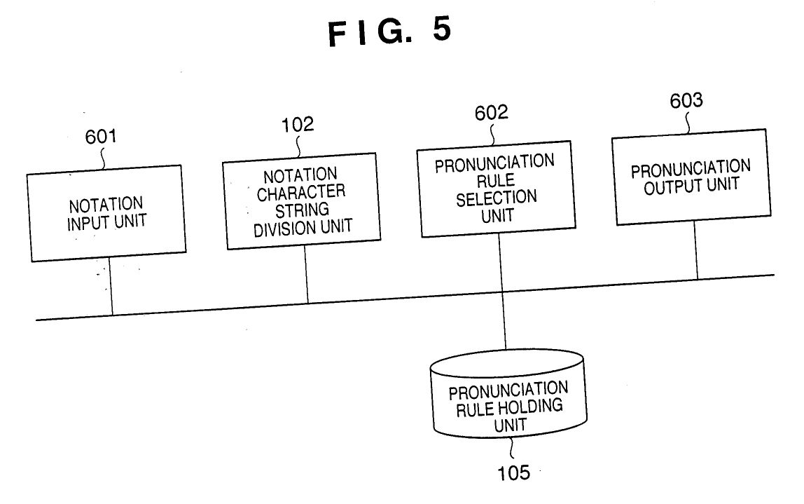

FIG. 5 is a block diagram showing the arrangement of a pronunciation estimation apparatus according to the second embodiment of the present invention.

Note that the same reference numerals denote the same building components as those in the pronunciation estimation apparatus of the first embodiment (FIG. 1) in FIG. 5, and a detailed description thereof will be omitted.

Reference numeral 601 denotes a notation input unit which inputs the notation of a word whose pronunciation is to be estimated.

Reference numeral 602 denotes a pronunciation rule selection unit which selects pronunciation rules from the pronunciation rule holding unit 105 using information of partial character strings obtained by dividing the notation of the word whose pronunciation is to be estimated by the notation character string division unit 102.

Reference numeral 603 denotes a pronunciation output unit which estimates and outputs the pronunciation of the word whose pronunciation is to be estimated using the pronunciation rules selected by the pronunciation rule selection unit 602.

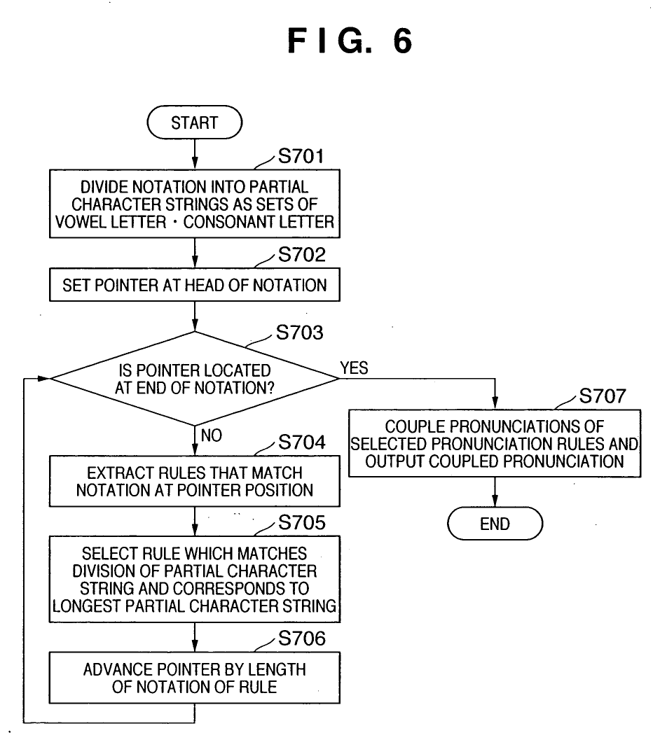

The process to be executed by the pronunciation estimation unit of the second embodiment will be described below using FIG. 6.

FIG. 6 is a flowchart showing the process to be executed by the pronunciation estimation apparatus according to the second embodiment of the present invention.

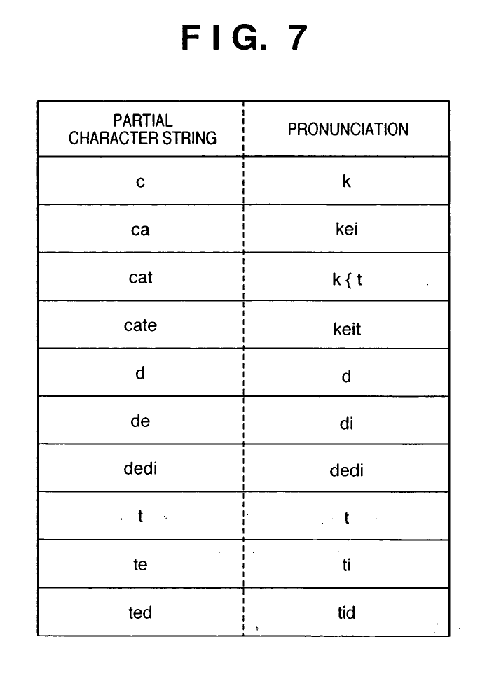

Note that FIG. 6 will explain the process for estimating a pronunciation of a word whose pronunciation is to be estimated on the basis of its notation. Especially, a case will be exemplified below wherein the pronunciation of a word is estimated from a notation “dedicated” of that word whose pronunciation is to be estimated. Also, 10 pronunciation rules (generated by the process of the first embodiment) shown in FIG. 7 are used. However, the frequencies of occurrence of pronunciation rules are omitted in FIG. 7 since they are not used upon estimating a pronunciation.

In step S701, the notation character string division unit 102 divides the word notation “dedicated” into partial character strings as sets of vowel letter-consonant letter. This process is the same as that in step S202 in FIG. 2. In this case, “dedicated” is divided into four partial character strings “de/di/ca/ted”, as described above.

In step S702, the pronunciation rule selection unit 602 sets a pointer at the head of the notation. In this case, the pointer is set at the position of “d” at the head of the notation.

The pronunciation rule selection unit 602 checks in step S703 if the pointer is located at the end of the notation. If the pointer is not located at the end of the notation (NO in step S703), the flow advances to step S704. On the other hand, if the pointer is located at the end of the notation (YES in step S703), the flow advances to step S707.

In step S704, the pronunciation rule selection unit 602 extracts pronunciation rules that match the notation starting from the pointer position from the pronunciation rule holding unit 105.

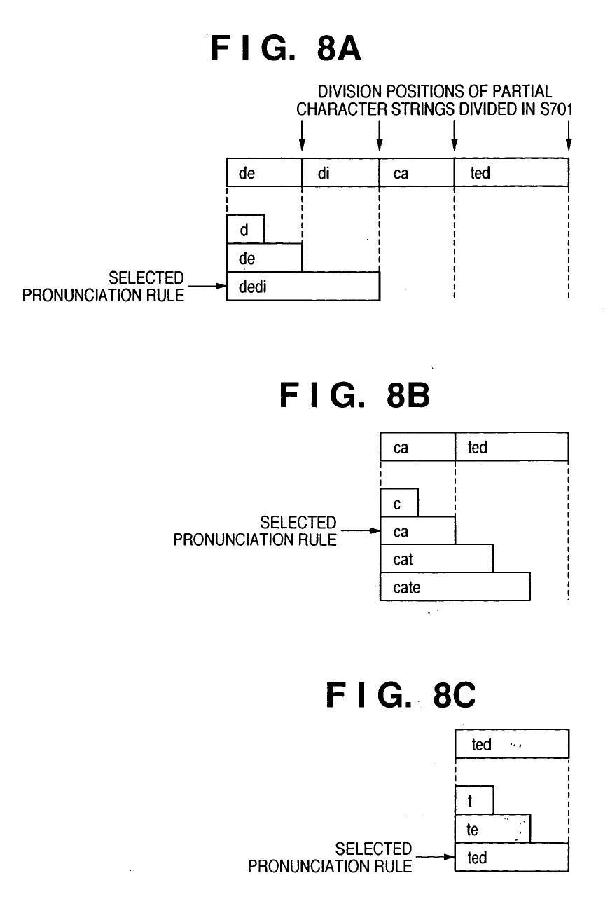

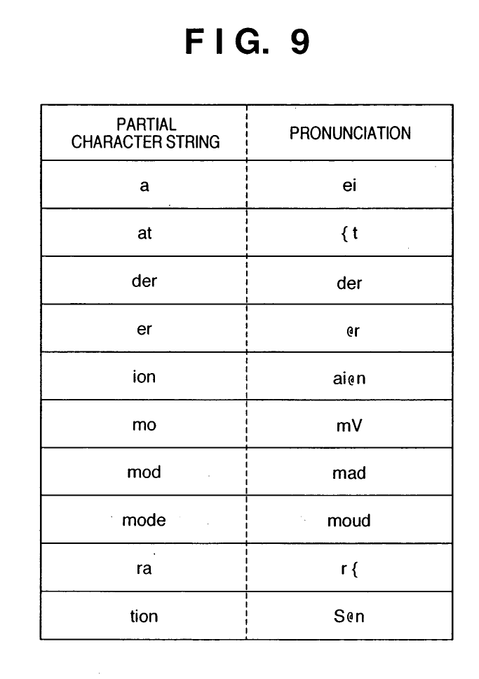

For example, if the pointer is located at the position of “d” at the head of the notation, three pronunciation rules “d”, “de”, and “dedi” are extracted, as shown in FIG. 8A.

On the other hand, if the pointer is located at the position of “c” as the fifth character, four pronunciation rules “c”, “ca”, “cat”, and “cate” are extracted, as shown in FIG. 8B.

Furthermore, if the pointer is located at the position of “t” as the seventh character, three pronunciation rules “t”, “te”, and “ted” are extracted, as shown in FIG. 8C.

In step S705, a pronunciation rule which matches the division position of the partial character string divided in step S701 and corresponds to the longest partial character string is selected from those which are extracted in step S704.

For example, a pronunciation rule “dedi” is selected in case of FIG. 8A.

In case of FIG. 8B, a pronunciation rule “ca” is selected. Note that pronunciation rules “cat” and “cate” are longer than “ca”, but they are not selected since they do not match the division position of the partial character string.

Furthermore, in case of FIG. 8C, a pronunciation rule “ted” is selected.

In step S706, the pointer is advanced by the length of the partial character string of the selected pronunciation rule. The flow then returns to step S703.

For example, in case of FIG. 8A, the pointer is advanced to the position of “c” as the fifth character.

On the other hand, if it is determined in step S703 that the pointer is located at the end of the notation, the pronunciation output unit 603 couples the pronunciations of the selected pronunciation rules and outputs them as an estimated pronunciation in step S707.

In this example, pronunciation rules “dedi”, “ca”, and “ted” are respectively selected in FIGS. 8A to 8C, and their pronunciations are respectively “dedi”, “kei”, and “tid”. A pronunciation “dedikeitid” generated by coupling these pronunciations is output as a pronunciation estimated from the notation “dedicated”.

As described above, according to the second embodiment, the pronunciation rules can be estimated by a simple process for scanning the notation from the head to the end of a word whose pronunciation is to be estimated once.

Since the notation character string division unit 102 is used as division means which is commonly used in generation of the pronunciation rules and estimation of a pronunciation, a problem of different divisions in generation of the pronunciation rules and estimation of a pronunciation can be avoided.

### Third Embodiment

In step S202 in FIG. 2 of the first embodiment or in step S701 in FIG. 7 of the seventh embodiment, the notation character string division unit 102 divides the notation of a word into partial character strings as sets of vowel letter-consonant letter. However, syllables may be used as partial character strings.

Especially, step S202 can be implemented using a word dictionary having information of syllabic divisions.

Also, in step S202 or S701, the notation can be automatically divided into syllables using, e.g., a method disclosed in U.S. Pat. No. 5,949,961 “WORD SYLLABLIFICATION IN SPEECH SYNTHESIS SYSTEM”.

Note that the present invention can be applied to an apparatus comprising a single device or to system constituted by a plurality of devices.

Furthermore, the invention can be implemented by supplying a software program, which implements the functions of the foregoing embodiments, directly or indirectly to a system or apparatus, reading the supplied program code with a computer of the system or apparatus, and then executing the program code. In this case, so long as the system or apparatus has the functions of the program, the mode of implementation need not rely upon a program.

Accordingly, since the functions of the present invention are implemented by computer, the program code installed in the computer also implements the present invention. In other words, the claims of the present invention also cover a computer program for the purpose of implementing the functions of the present invention.

In this case, so long as the system or apparatus has the functions of the program, the program may be executed in any form, such as an object code, a program executed by an interpreter, or scrip data supplied to an operating system.

Example of storage media that can be used for supplying the program are a floppy disk, a hard disk, an optical disk, a magneto-optical disk, a CD-ROM, a CD-R, a CD-RW, a magnetic tape, a non-volatile type memory card, a ROM, and a DVD (DVD-ROM and a DVD-R).

As for the method of supplying the program, a client computer can be connected to a website on the Internet using a browser of the client computer, and the computer program of the present invention or an automatically-installable compressed file of the program can be downloaded to a recording medium such as a hard disk. Further, the program of the present invention can be supplied by dividing the program code constituting the program into a plurality of files and downloading the files from different websites. In other words, a WWW (World Wide Web) server that downloads, to multiple users, the program files that implement the functions of the present invention by computer is also covered by the claims of the present invention.

It is also possible to encrypt and store the program of the present invention on a storage medium such as a CD-ROM, distribute the storage medium to users, allow users who meet certain requirements to download decryption key information from a website via the Internet, and allow these users to decrypt the encrypted program by using the key information, whereby the program is installed in the user computer.

Besides the cases where the aforementioned functions according to the embodiments are implemented by executing the read program by computer, an operating system or the like running on the computer may perform all or a part of the actual processing so that the functions of the foregoing embodiments can be implemented by this processing.

Furthermore, after the program read from the storage medium is written to a function expansion board inserted into the computer or to a memory provided in a function expansion unit connected to the computer, a CPU or the like mounted on the function expansion board or function expansion unit performs all or a part of the actual processing so that the functions of the foregoing embodiments can be implemented by this processing.

As many apparently widely different embodiments of the present invention can be made without departing from the spirit and scope thereof, it is to be understood that the invention is not limited to the specific embodiments thereof except as defined in the appended claims.

### CLAIM OF PRIORITY

This application claims priority from Japanese Patent Application No. 2003-415426 filed on Dec. 12, 2003, which is hereby incorporated by reference herein.

1. An information processing apparatus, comprising:
division means for acquiring a word to be processed from a word dictionary which includes a plurality of word each having notation information and pronunciation information, and dividing a notation of the acquired word into a plurality of character strings;
coupling means for generating partial character strings by coupling neighboring ones of the plurality of partial character strings divided by said division means;
registration means for determining pronunciations corresponding to the partial character strings obtained by said division means and said coupling means, and registering sets of partial character strings and pronunciations as pronunciation rules in a pronunciation rule holding unit; and
deletion means for deleting registered pronunciation rules on the basis of frequencies of occurrence of pronunciation rules registered in the pronunciation rule holding unit.

2. The apparatus according to claim 1, wherein when pronunciation rules having different pronunciations are registered in correspondence with a single partial character string in the pronunciation rule holding unit, said deletion means deletes pronunciation rules other than a pronunciation rule with a highest frequency of occurrence.

3. The apparatus according to claim 1, further comprising:
receive means for receiving a word whose pronunciation is to be estimated;
selection means for selecting pronunciation rules from the pronunciation rule holding unit using information of a plurality of partial character strings obtained by dividing a notation of the word whose pronunciation is to be estimated by said division means; and
estimation means for estimating a pronunciation of the word whose pronunciation is to be estimated using the pronunciation rules selected by said selection means.

4. The apparatus according to claim 1, wherein said division means divides the notation of the word into a plurality of partial character strings using vowel letter-consonant letter information.

5. The apparatus according to claim 1, wherein said division means divides the notation of the word into a plurality of partial character strings using information associated with syllabic divisions.

6. An information processing apparatus, comprising:
receive means for receiving a notation of the word to be processed;
division means for dividing the notation of the word to be processed into a plurality of partial character strings;
selection means for selecting pronunciation rules from holding means that holds pronunciation rules using information of the partial character strings divided by said division means; and
estimation means for estimating a pronunciation of the word to be processed using the pronunciation rules selected by said selection means.

7. The apparatus according to claim 6, wherein said division means divides the notation of the word into a plurality of partial character strings using vowel letter-consonant letter information.

8. The apparatus according to claim 6, wherein said division means divides the notation of the word into a plurality of partial character strings using information associated with syllabic divisions.

9. The apparatus according to claim 6, wherein said selection means selects a pronunciation rule that matches a division position of each partial character string divided by said division means and corresponds to a longest partial character string.

10. A method of controlling an information processing apparatus, comprising:
a division step of acquiring a word to be processed from a word dictionary which includes a plurality of word each having notation information and pronunciation information, and dividing a notation of the acquired word into a plurality of character strings;
a coupling step of generating partial character strings by coupling neighboring ones of the plurality of partial character strings divided in the division step;
a registration step of determining pronunciations corresponding to the partial character strings obtained in the division step and the coupling step, and registering sets of partial character strings and pronunciations as pronunciation rules in a pronunciation rule holding unit; and
a deletion step of deleting registered pronunciation rules on the basis of frequencies of occurrence of pronunciation rules registered in the pronunciation rule holding unit.

11. A method of controlling an information processing apparatus, comprising:
an receive step of receiving a notation of the word to be processed;
a division step of dividing the notation of the word to be processed into a plurality of partial character strings;
a selection step of selecting pronunciation rules from a pronunciation rule holding unit that holds pronunciation rules using information of the partial character strings divided in the division step; and
an estimation step of estimating a pronunciation of the word to be processed using the pronunciation rules selected in the selection step.

12. A program for implementing control of an information processing apparatus, comprising:
a program code of a division step of acquiring a word to be processed from a word dictionary which includes a plurality of word each having notation information and pronunciation information, and dividing a notation of the acquired word into a plurality of character strings;
a program code of a coupling step of generating partial character strings by coupling neighboring ones of the plurality of partial character strings divided in the division step;
a program code of a registration step of determining pronunciations corresponding to the partial character strings obtained in the division step and the coupling step, and registering sets of partial character strings and pronunciations as pronunciation rules in a pronunciation rule holding unit; and
a program code of a deletion step of deleting registered pronunciation rules on the basis of frequencies of occurrence of pronunciation rules registered in the pronunciation rule holding unit.

13. A program for implementing control of an information processing apparatus, comprising:
a program code of an receive step of receiving a notation of the word to be processed;
a program code of a division step of dividing the notation of the word to be processed into a plurality of partial character strings;
a program code of a selection step of selecting pronunciation rules from a pronunciation rule holding unit that holds pronunciation rules using information of the partial character strings divided in the division step; and
a program code of an estimation step of estimating a pronunciation of the word to be processed using the pronunciation rules selected in the selection step.
